(19) United States
(12) Patent Application Publication
(10) Pub. No.: US 2011/0232446 A1
(43) Pub. Date: Sep. 29, 2011

(54) SAFETY MATERIAL FEEDING DEVICE

(76) Inventor: Tung-Wei CHANG, Ta Ya Hsiang (TW)

(21) Appl. No.: 12/748,388

(22) Filed: Mar. 27, 2010

(51) Int. Cl. B23D 59/00

(52) U.S. Cl. 83/431

(57) ABSTRACT

A safety material feeding device installable on a saw machine for pushing and moving a work material on a working platform of the saw machine to saw the work material with a saw blade. The safety material feeding device includes: a bed section fixedly disposed on the saw machine; a material feeding section pivotally disposed on the bed section and reciprocally moved between a backward position, which is out of a movement path of the work material on the working platform and a forward position; and a transmission section for driving the material feeding section to move from the backward position to the forward position. When moved from the backward position to the forward position, one end of the material feeding section is moved into contact with the work material to push the work material toward the saw blade of the saw machine to be sawed by the saw blade.

### BACKGROUND OF THE INVENTION

1. Field of the Invention

The present invention relates generally to a sawing technique, and more particularly to a safety material feeding device.

2. Description of the Related Art

A conventional saw machine such as a vertical band saw machine or a bench circular saw machine is used to saw a work material. The saw machine provides a working platform for placing a work material thereon. An operator can push the work material along the working platform to saw the work material with a band saw blade or a circular saw blade.

It is dangerous for an operator to bare-handed push a work material to the operating band saw blade or circular saw blade. Therefore, an operator can hold a pushing board 1 with both hands to indirectly push a work material along the working platform of the band saw machine 2 or circular saw machine 3 as shown in FIGS. 1 and 2. Under such circumstance, the operator's hands can keep spaced from the operating band saw blade or circular saw blade by a safety distance so as to avoid a workplace accident.

However, such pushing board 1 is still not idealistic and unreliable. Moreover, the application of such pushing board 1 is limited.

### SUMMARY OF THE INVENTION

It is therefore a primary object of the present invention to provide a safety material feeding device, which can ensure an operator to saw a work material with a saw machine in a safe working condition.

It is a further object of the present invention to provide the above safety material feeding device, which is integrated with the saw machine to facilitate operation and promote working efficiency.

To achieve the above and other objects, the safety material feeding device of the present invention is installable on a saw machine for pushing and moving a work material on a working platform of the saw machine to saw the work material with a saw blade of the saw machine. The safety material feeding device includes: a bed section fixedly disposed on the saw machine; a material feeding section pivotally disposed on the bed section and reciprocally moved between a backward position and a forward position; and a transmission section for transmitting external force to the material feeding section and driving the material feeding section to move from the backward position to the forward position. When the material feeding section is positioned in the backward position, the material feeding section is positioned out of a movement path of the work material on the working platform. When the material feeding section is moved from the backward position to the forward position, one end of the material feeding section being moved into contact with the work material to push the work material toward the saw blade of the saw machine to be sawed by the saw blade.

The present invention can be best understood through the following description and accompanying drawings, wherein:

### BRIEF DESCRIPTION OF THE DRAWINGS

FIG. 1 is a perspective view showing that a work material is pushed to a band saw blade via a conventional pushing board;

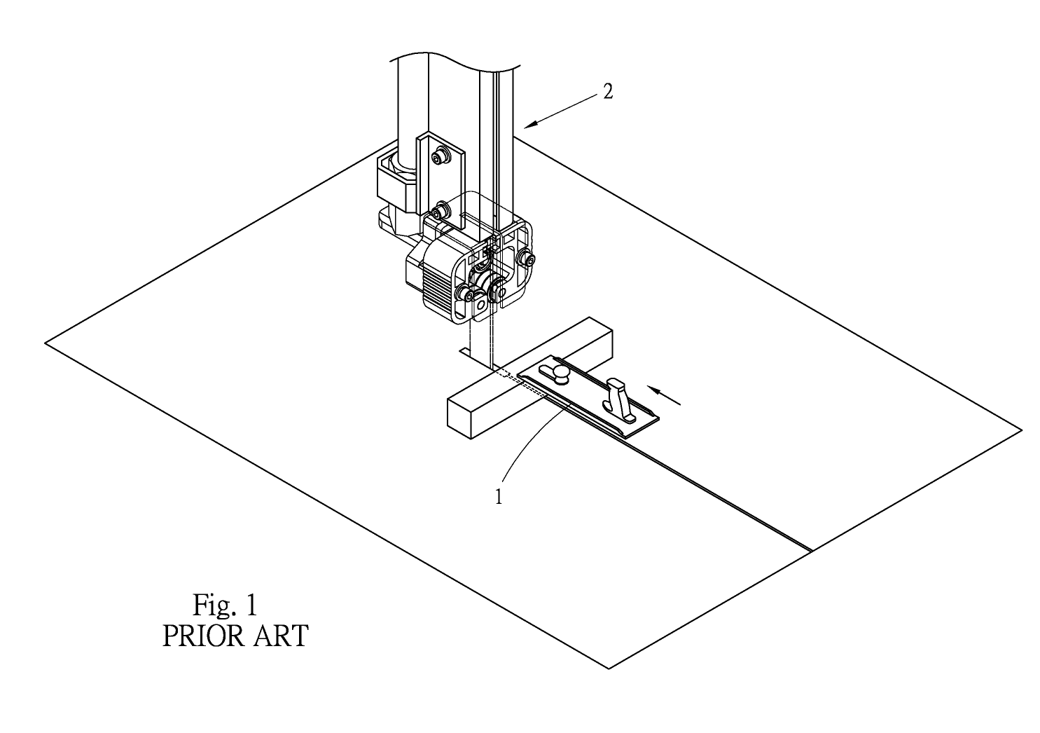

FIG. 2 is a perspective view showing that a work material is pushed to a circular saw blade via the conventional pushing board;

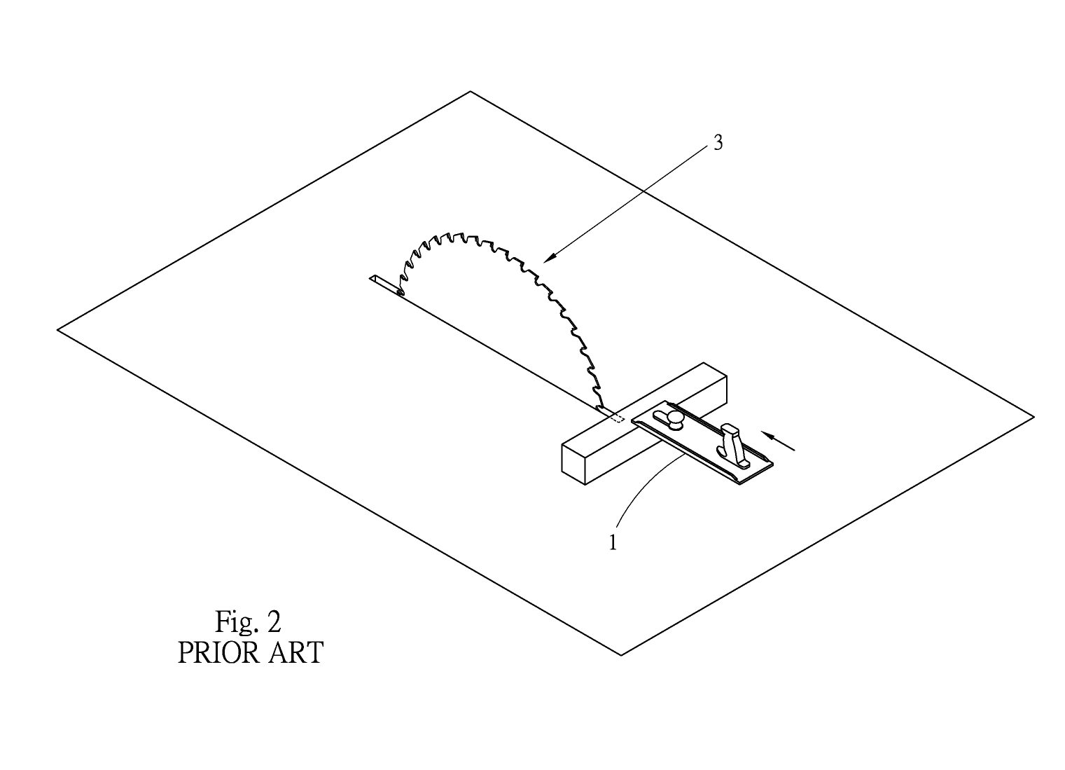

FIG. 3 is a perspective assembled view of a preferred embodiment of the safety material feeding device of the present invention;

FIG. 4 is a perspective view showing that the safety material feeding device of the present invention is applied to a vertical band saw machine;

FIG. 5 is a side view showing that the safety material feeding device of the present invention is applied to a vertical band saw machine, in which the material feeding section is positioned in a backward position;

FIG. 6 is a side view showing that the safety material feeding device of the present invention is applied to a vertical band saw machine, in which the material feeding section is moved from the backward position to a forward position; and

FIG. 7 is a side view showing that the safety material feeding device of the present invention is applied to a vertical band saw machine, in which the material feeding section is positioned in the forward position.

### DETAILED DESCRIPTION OF THE PREFERRED EMBODIMENTS

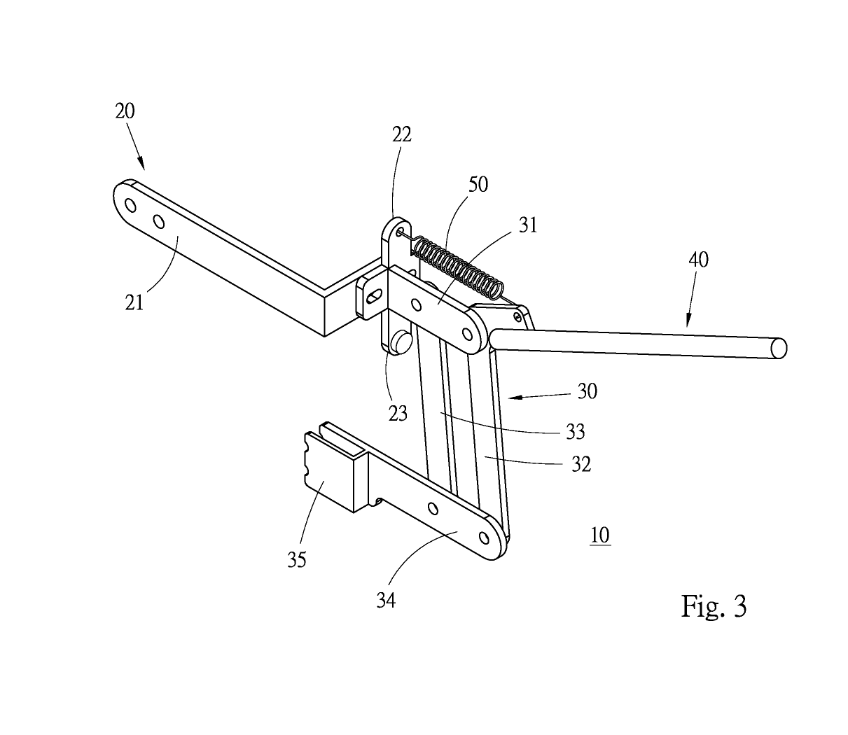

Please first refer to FIG. 3. According to a preferred embodiment, the safety material feeding device 10 of the present invention includes a bed section 20, a material feeding section 30, a transmission section 40 and a resilient section 50.

The bed section 20 includes an L-shaped elongated bed board 21, an upper lug 22 protruding from one side of one end of the bed board 21, and a lower lug 23 protruding from another side of the end of the bed board 21.

The material feeding section 30 can be formed of a parallel rule, including an elongated bar-like fixed member 31. One end of the fixed member 31 is fixedly connected to the bed board 21. The material feeding section 30 further includes two elongated links 32, 33. First ends of the links 32, 33 are pivotally connected to the fixed member 31 with the links 32, 33 in parallel to each other. An elongated bar-like movable member 34 is pivotally connected to second ends of the links 32, 33 in parallel to the fixed member 31. The material feeding section 30 further includes a U-shaped pushing member 35 having a closed end and an open end. The closed end of the pushing member 35 is fixedly connected to one end of the movable member 34.

The transmission section 40 is an elongated handle. One end of the transmission section 40 is fixedly connected to the link 32.

The resilient section 50 is a spring. Two ends of the resilient section 50 are respectively hooked with the upper lug 22 and the transmission section 40 with the resilient section 50 positioned there between.

According to the above arrangement, the bed section 20 is fixedly connected to a saw machine such as a vertical band saw machine or a bench circular saw machine for pushing a work piece or a work material to be sawed. In this case, an operator can feed the material to the band saw blade or circular saw blade of the saw machine for sawing operation in a safe working condition.

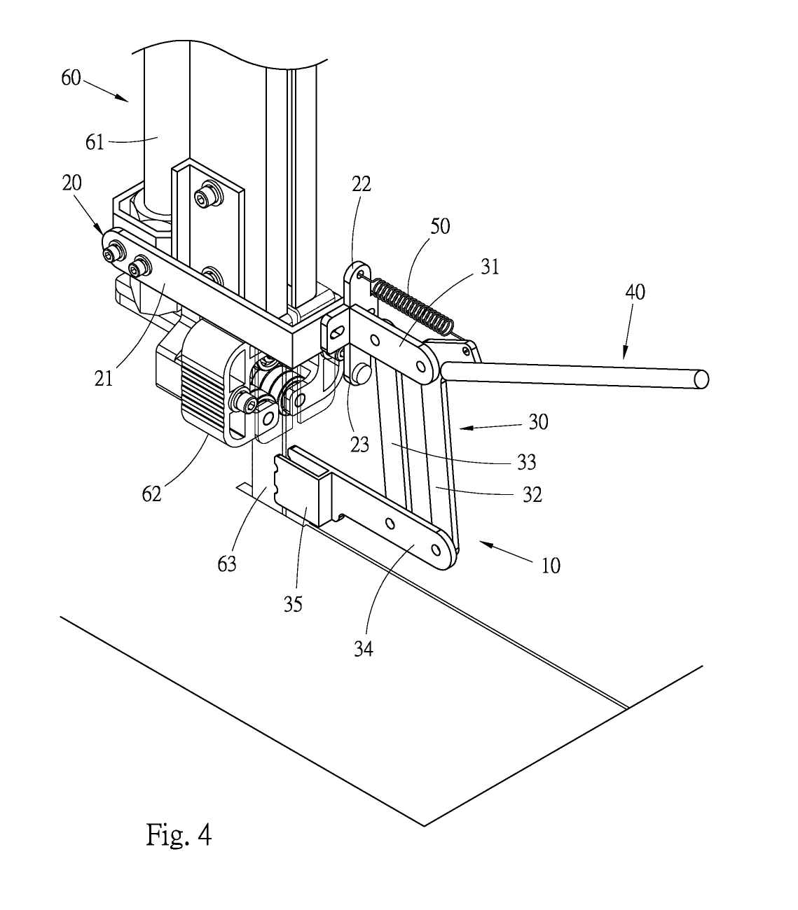

To speak more specifically, referring to FIGS. 4 to 7, exemplified with a vertical band saw machine, the bed board 21 of the safety material feeding device 10 of the present invention is affixed to an end of a guide pin 61 of the vertical band saw machine 60 by means of fixing members such as bolts. The end of the bed board 21 extends to a position in front of a band saw blade holding mechanism 62 of the band saw machine 60. Accordingly, the material feeding section 30 is positioned in front of a band saw blade 63 of the band saw machine 60.

The movable member 34 of the material feeding section 30 is pivotally connected to the fixed member 31 via the links 32, 33, whereby the movable member 34 can be reciprocally moved between a backward position and a forward position always in parallel to the fixed member 31.

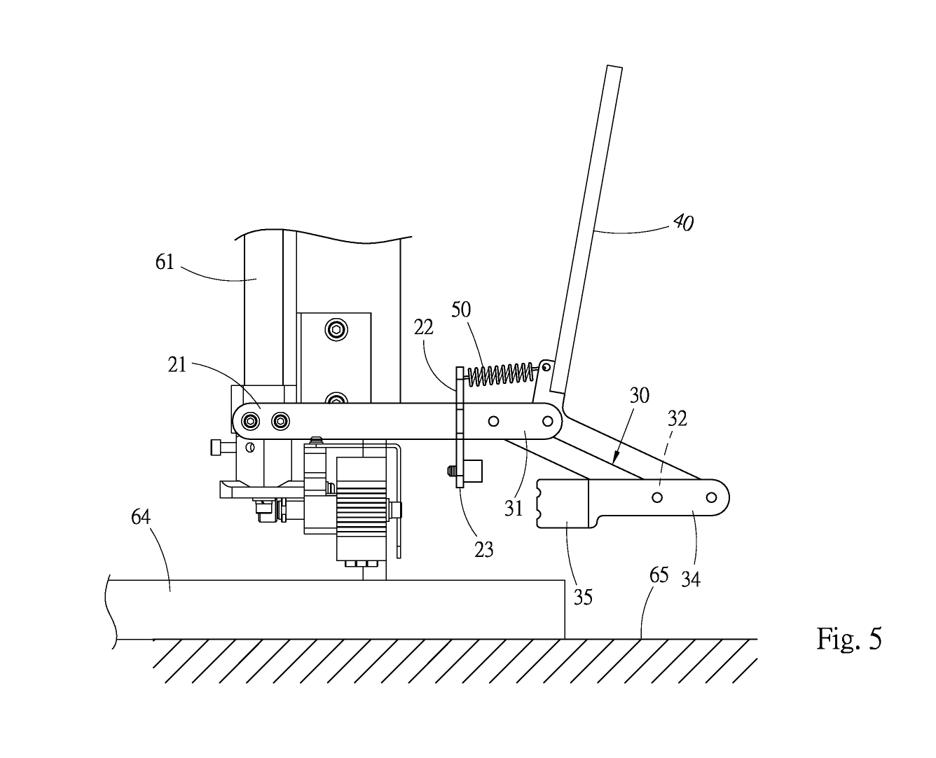

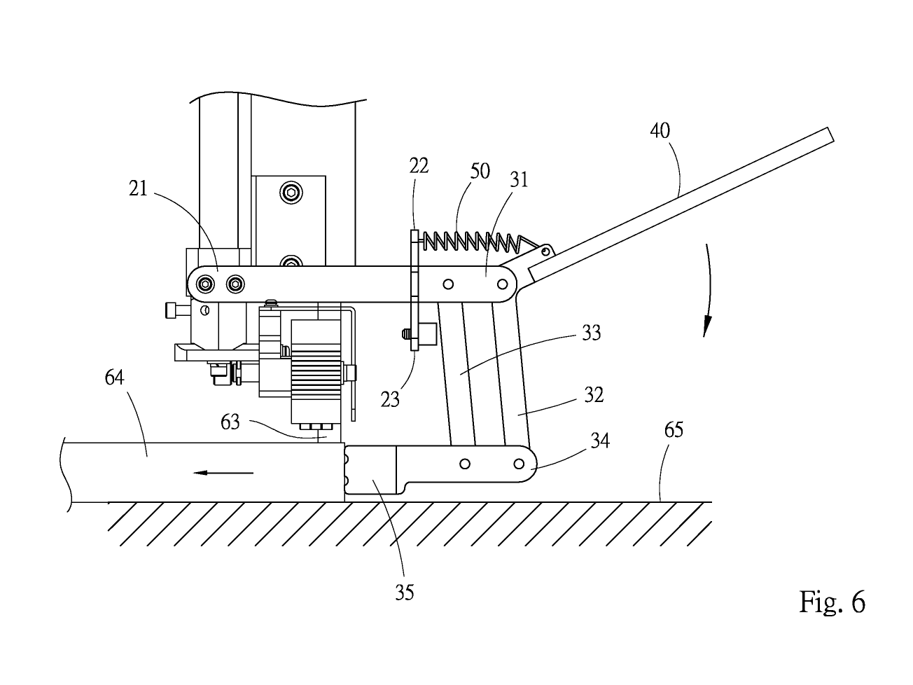

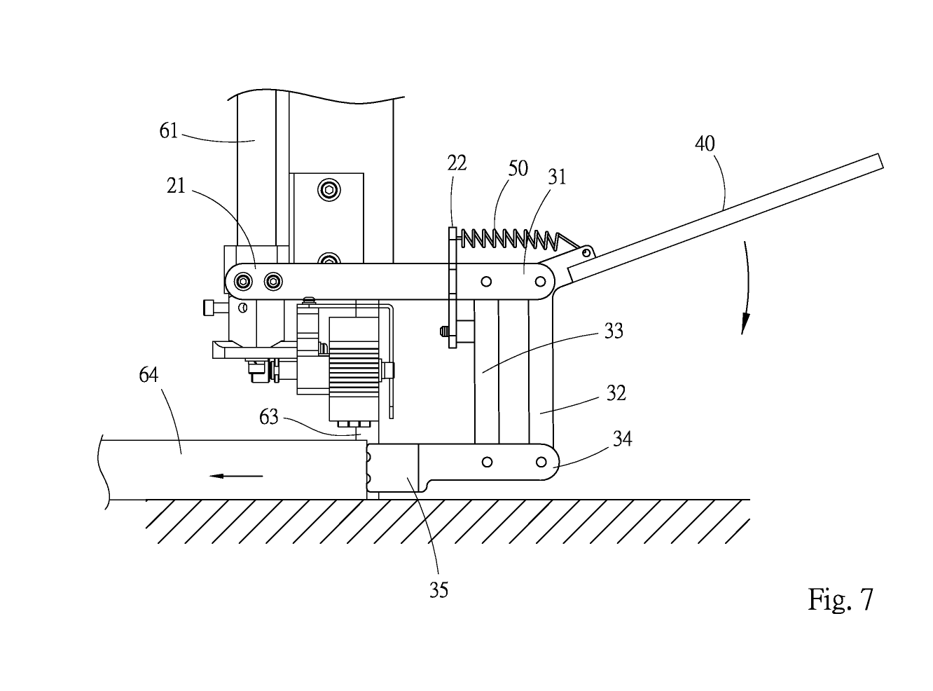

In sawing operation, an operator first pushes the work material 64 barehanded or with a tool to make the work material 64 move on a platform 65 of the band saw machine 60 to be preliminarily sawed by the band saw blade 63. Then the operator manually shifts the transmission section 40 to make the material feeding section 30 move from the backward position toward the forward position as shown in FIG. 5. When the material feeding section 30 is moved to the forward position, the pushing member 35 is moved into contact with the work material 64 to further push the work material 64 to the band saw blade 63 for sawing operation as shown in FIG. 6. When the movable member 34 of the material feeding section 30 reaches the forward position, the band saw blade 63 extends into the space of the U-shaped pushing member 35. In this case, the work material 64 can be fully cut by the band saw blade 63 as shown in FIG. 7.

Accordingly, the operator can quickly and safely operate the safety material feeding device 10 to feed the work material to the band saw machine to complete the sawing operation in a safe working condition. It should be noted that:
1. The resilient section 50 serves to resiliently keep the material feeding section 30 in the backward position, which is out of the movement path of the work material on the platform. Therefore, when not used, the safety material feeding device 10 will not obstruct an operator from working.
2. The safety material feeding device 10 is applicable to, but not limited to, the vertical band saw machine. In practice, the configuration of the bed section can be modified in adaptation to different saw machines. Moreover, the safety material feeding device 10 can be embedded in or arranged under the working platform of a band saw machine or a circular saw machine. Such modification can be easily made by those skilled in this field.
3. The transmission section can be, but not limited to, an elongated handle for an operator to manually shift. In practice, the transmission section can be alternatively a cord, whereby an operator can pull the cord to move the material feeding section.
4. A stopper bolt is screwed in the lower lug 23 of the material feeding section 30 for stopping the material feeding section 30 at the forward position. Accordingly, the depth at which the band saw blade extends into the U-shaped pushing member 35 can be adjusted by means of the stopper bolt.

The above embodiments are only used to illustrate the present invention, not intended to limit the scope thereof. Many modifications of the above embodiments can be made without departing from the spirit of the present invention.

What is claimed is:

1. A safety material feeding device installable on a saw machine for pushing and moving a work material on a working platform of the saw machine to saw the work material with a saw blade of the saw machine, the safety material feeding device comprising:
a bed section fixedly disposed on the saw machine;
a material feeding section pivotally disposed on the bed section and reciprocally moved between a backward position and a forward position; and
a transmission section for transmitting external force to the material feeding section and driving the material feeding section to move from the backward position to the forward position, when the material feeding section is positioned in the backward position, the material feeding section being positioned out of a movement path of the work material on the working platform, when the material feeding section is moved from the backward position to the forward position, one end of the material feeding section being moved into contact with the work material to push the work material toward the saw blade of the saw machine to be sawed by the saw blade.

2. The safety material feeding device as claimed in claim 1, wherein the material feeding section includes a fixed member and a movable member, the movable member being movable in parallel to the fixed member, one end of the movable member serving to push the work material.

3. The safety material feeding device as claimed in claim 2, wherein the material feeding section further includes two links, first ends of the links being pivotally connected to the fixed member, while second ends of the links being pivotally connected to the movable member with the links bridged between the fixed member and the movable member in parallel to each other, whereby the fixed member, the movable member and the two links together form a parallel rule.

4. The safety material feeding device as claimed in claim 2, wherein the material feeding section further includes a pushing member protruding from one end of the movable member for pushing an end face of the work material.

5. The safety material feeding device as claimed in claim 4, wherein the pushing member is a U-shaped member having a closed end fixedly connected to the end of the movable member.

6. The safety material feeding device as claimed in claim 1, further comprising a resilient section for providing resilient force to resiliently keep the material feeding section in the backward position.

7. The safety material feeding device as claimed in claim 1, wherein the transmission section is a handle one end of which is connected to the material feeding section.

8. The safety material feeding device as claimed in claim 1, wherein the transmission section is a cord.
